(19) United States
(12) Patent Application Publication
(10) Pub. No.: US 2026/0202279 A1
(43) Pub. Date: Jul. 16, 2026

(54) AERIAL METHANE GAS LEAK DETECTION POD

(71) Applicant: Vanguard Pipeline Inspection LLC, Maple Lake, MN (US)

(72) Inventors: James T. Aarestad, Buffalo, MN (US); Nathan A. Holmberg, Albertville, MN (US)

(21) Appl. No.: 19/135,145

(22) PCT Filed: Dec. 7, 2023
(86) PCT No.: PCT/US2023/082860

§ 371 Date: Jun. 3, 2025

Related U.S. Application Data
(60) Provisional application No. 63/432,872, filed on Dec. 15, 2022.

(51) Int. Cl. G01M 3/38; B64D 47/08

(52) U.S. Cl. CPC G01M 3/38; B64D 47/08

(57) ABSTRACT

An aerial methane gas leak detector pod is mountable to a wing strut of a fixed wing aircraft. The pod includes an external shell assembly and a scope assembly that is mounted within the external shell assembly. The scope assembly includes a scope tube with a scope window, an infrared laser, a video camera, a multi-mirror system, and a photon detector. The infrared laser directs a laser beam out through the scope window to illuminate a gas leak along a pipeline. Backscattered laser light produced by interaction of the laser beam with the gas leak is collected by the mirror system and directed to and sensed by the photon detector. The scope is rotatable by a motor based upon video from the video camera. The scope assembly is vibration isolated from the external shell.

### CROSS-REFERENCE TO RELATED APPLICATION(S)

This application is a Section 371 National Stage Application of International Application No. PCT/US2023/082860, filed on Dec. 7, 2023, entitled “AERIAL METHANE GAS LEAK DETECTION POD,” which claims the benefit of U.S. Provisional Application No. 63/432,872, filed Dec. 15, 2022, and entitled “AERIAL METHANE GAS LEAK DETECTION POD,” the disclosure of which is hereby incorporated by reference in its entirety.

### BACKGROUND

Gas leak detection is an important part of a pipeline integrity management program to comply with leak detection requirements of government regulations from agencies such as the United States Department of Transportation (DOT) and Environmental Protection Agency (EPA) regulations. A monitoring program may include periodic inspections in which an aircraft (for example, a helicopter or a fixed wing aircraft) flies along the path of the pipeline. The aircraft carries a downward looking gas detection sensor system to identify gas leaks from the pipeline.

### SUMMARY

In one embodiment, an aerial methane gas leak detection pod includes an external shell assembly, a scope assembly, an infrared laser, a photon detector, and a mirror assembly. The external shell assembly includes a main body having a front end, a rear end, and an external shell window in a wall of the main body. The scope assembly is coaxially positioned along a longitudinal axis within the external shell assembly. The scope assembly includes a scope tube, a rear end, a front end, and a scope window in a wall of the scope tube. The infrared laser is mounted within the scope assembly and is positioned to direct an infrared laser beam out through the scope window and the external shell window. The photon detector is mounted on the scope assembly for receiving backscattered infrared light produced by the interaction of the infrared laser beam with a methane gas leak. The mirror system is mounted within the scope assembly to collect backscattered infrared light received through the scope window and to direct the backscattered infrared light to the photon detector.

In another embodiment, an aerial methane gas leak detection pod includes a scope assembly, an external shell assembly, a motor, and a motor shaft. The scope assembly includes a scope tube; a scope window in the scope tube; an infrared laser mounted in the scope tube that directs an infrared laser beam through the scope window; a video camera mounted in the scope tube; a photon detector; and a mirror system mounted within the scope tube to collect backscattered infrared light received through the scope window and to direct the backscattered infrared light to the photon detector. The external shell assembly surrounds and is coaxial with the scope assembly. The external shell assembly includes a main body having a front end, a rear end, and an external shell window in a wall of the main body. The motor is mounted to the external shell assembly. The motor shaft is connected to the scope assembly to rotate the scope assembly within the external shell assembly.

### BRIEF DESCRIPTION OF THE DRAWINGS

FIG. 1A is a side view of a fixed wing aircraft with an aerial methane detection pod mounted to a strut of the aircraft.

FIG. 1B is a front view of the fixed wing aircraft with the aerial methane detection pod mounted to a strut of the aircraft.

FIG. 2A is an exploded isometric view of an aerial methane detection pod.

FIG. 2B is an assembled isometric view of the aerial methane detection pod.

FIG. 3A is an exploded side view of the aerial methane detection pod.

FIG. 3B is an assembled side view of the aerial methane detection pod.

FIG. 4 is an exploded side view of an external shell assembly of the methane detection pod.

FIG. 5 is an exploded isometric view of the external shell assembly.

FIG. 6 is an exploded front end view of the external shell assembly.

FIG. 7 is an assembled front end view of the external shell assembly.

FIG. 8 is a section view of the external shell assembly along section A-A of FIG. 7.

FIG. 9 is an exploded side view of a scope assembly of the aerial methane detector pod.

FIG. 10 is an exploded isometric view of the scope assembly.

FIG. 11 is a cross-sectional view of the assembled scope assembly.

FIG. 12 is a bottom view of the aerial methane detection pod.

FIG. 13 is a front view of a collection mirror assembly.

FIG. 14 is a sectional view of the collection mirror assembly, along section B-B of FIG. 13.

FIG. 15 is an isometric view of the collection mirror assembly.

FIG. 16 is a rear view of the collection mirror assembly.

FIG. 17 is an exploded isometric view showing components of the collection mirror assembly.

FIG. 18 is an exploded isometric view of the collection mirror assembly.

FIG. 19 shows a motor mount assembly attached to a rear end of the scope assembly.

FIG. 20 shows an isometric view from below the scope assembly with the motor mount assembly connected to the scope assembly.

FIG. 21 is an exploded isometric view showing the scope assembly and the motor mount assembly.

FIG. 22 and FIG. 23 are exploded isometric views of a motor mount assembly.

FIG. 24 is a side view, with main body removed, showing an auto track system of the aerial methane detection pod.

FIG. 25 is an isometric view showing vibration isolator system that supports and isolates the laser and electronics of the scope assembly from aircraft engine vibration.

FIG. 26 is a cross-sectional view of the aerial methane detection pod showing a laser beam from the pod intersecting a methane gas cloud, and showing a path of backscattered laser light from the methane gas cloud to the photon detector of the pod.

### DETAILED DESCRIPTION

### Overview

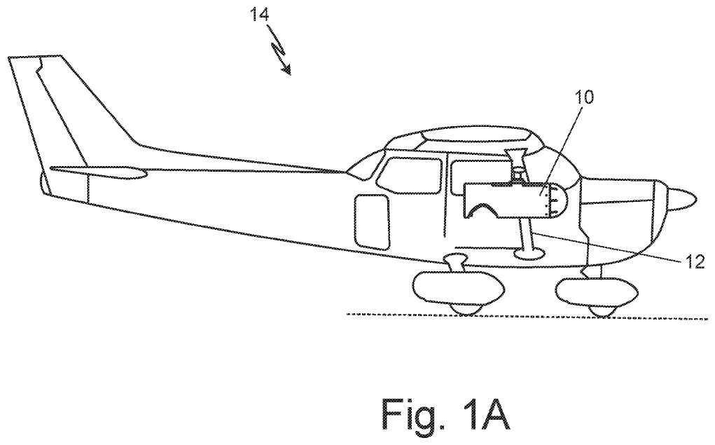

FIGS. 1A and 1B show front and side views of aerial methane detection pod 10 mounted on wing strut 12 of fixed wing aircraft 14. Examples of fixed wing aircraft suitable for use with aerial methane detection pod 10 include Cessna 172, Cessna 182, and Cessna 206 aircraft.

### Pod 10

Aerial methane detection pod 10 (which will be referred to as “pod 10”) uses a safe low-powered infrared laser to sense the amount of methane near the pipeline. The wavelength is tuned so that the infrared laser beam reflects off methane molecules. By measuring the amount of backscattered infrared light that bounces off methane molecules and is reflected back to pod 10, the intensity and location of the gas leak can be determined.

Pod 10 is stabilized and the laser beam can be pointed up to 25 degrees left or right of course. The system automatically compensates for turbulence and allows operators to follow the pipeline and thereby ensure the laser always stays pointed over the pipeline right of way. This allows the laser to stay on track even if the pilot is not flying directly over the pipeline.

Pod 10 gives users full control over the sensitivity of the system. By adjusting the sensitivity, operators can select how large of a leak they want to detect. This can allow operators to focus on fixing the larger leaks first and, over time, find the smaller leaks later.

Pod 10 can be used as part of a pipeline integrity management program to comply with the gas leak detection requirements of DOT and EPA regulations. It allows existing pipeline patrol aircraft equipped with pod 10 to find gas leaks while on routine pipeline patrols.

If pod 10 senses a gas leak, the data is completely confidential. The software of an electronic unit of pad 10 gives users full control over who sees the location of the gas leaks. The data is safely stored on the app and is not uploaded to the cloud. Only the pilot knows about any gas leaks. If desired, after the flight, the pilot can email the sensor readings to the pipeline owner.

Pod 10 is easy to use. Unlike other technology, it requires no complex post-flight analysis, and it instantly alerts the pilot if a methane gas leak is found. Training pilots is easy and can be done in a short flight. Operators can use, for example, an iPad app to monitor and control the system in flight. A downward-facing video camera gives operators a clear view of the entire right or way.

Pod 10 is designed to be an affordable methane detection system for pipeline owners and pipeline patrol companies. When compared to helicopter-based leak detection systems, aerial methane detection pod 10 compares favorably with respect to affordability, safety, quietness, and efficiency.

Features of pod 10 includes external shell assembly 16, scope assembly 18, collection mirror assembly 20, motor mount 22, auto track control 24, vibration isolation system 26, and gas cloud interaction 28.

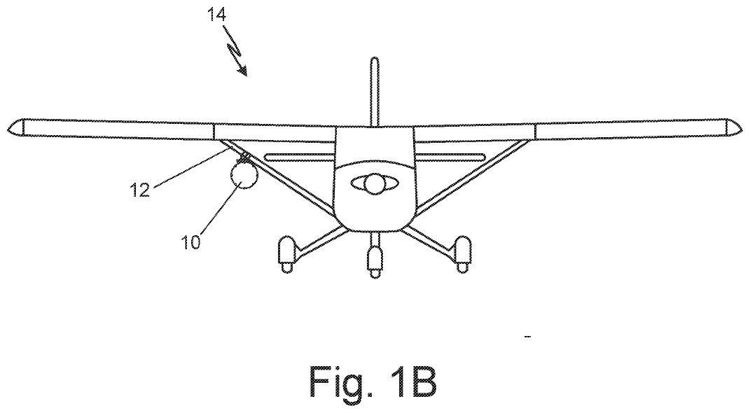

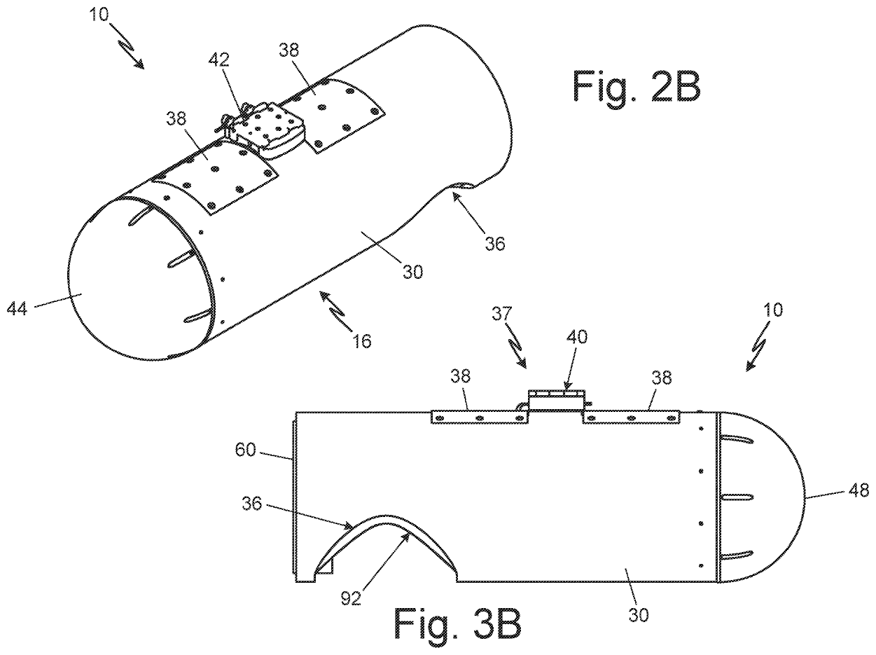

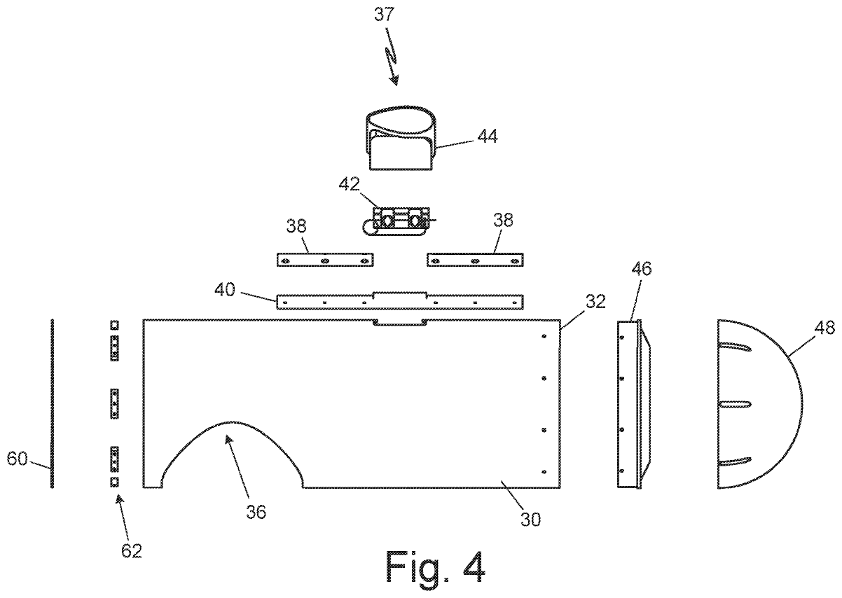

FIGS. 2A, 2B, 3A, 3B, and 4-8 will be discussed together is conjunction with external shell assembly 16.

FIGS. 2A, 2B, 3A, 3B, and 9-13 will be discussed together in conjunction with scope assembly 18.

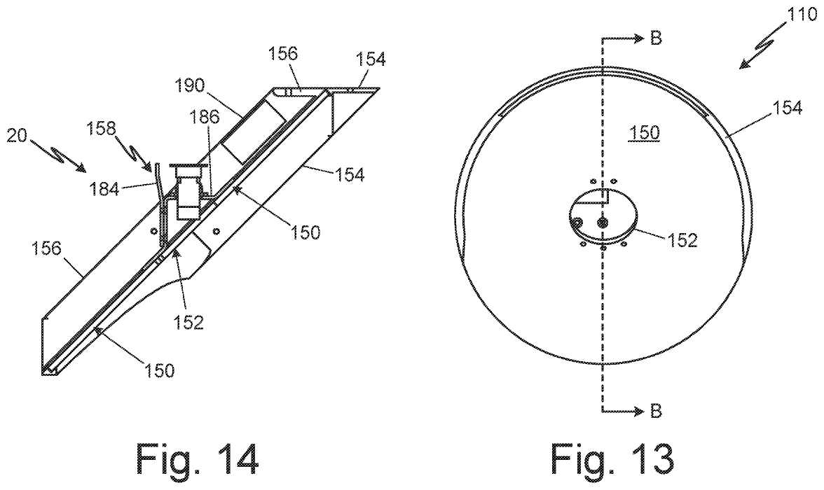

FIGS. 14-18 will be discussed together in conjunction with collection mirror assembly 20.

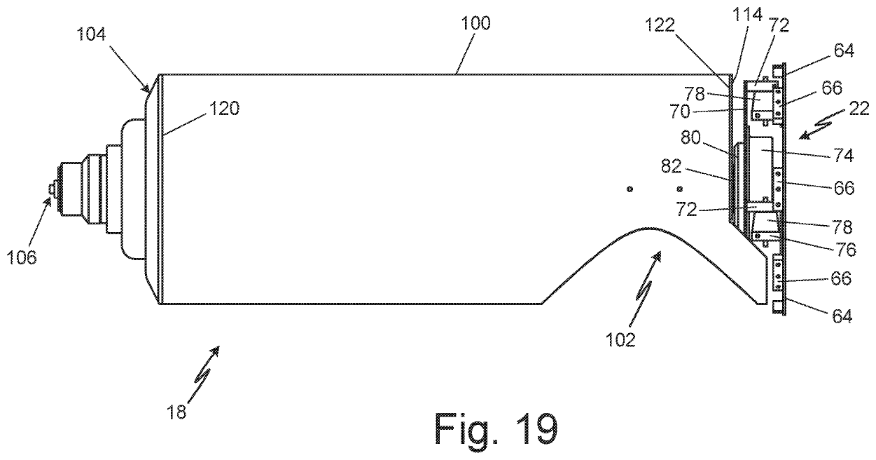

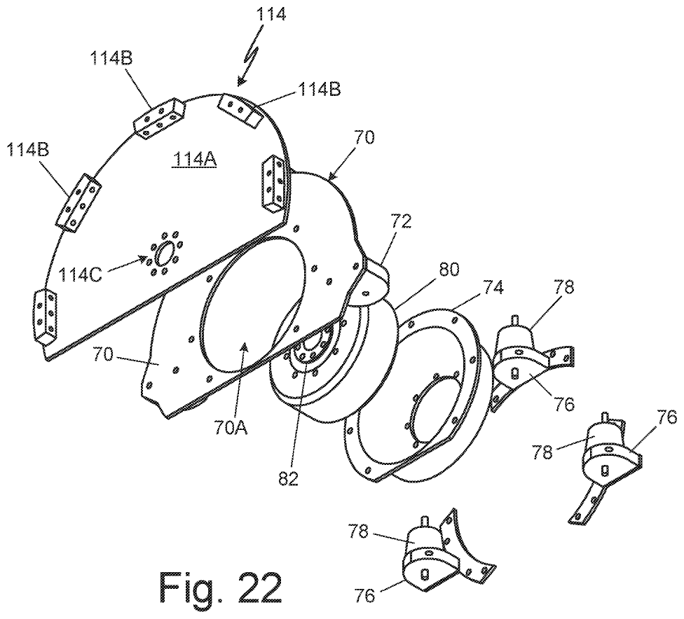

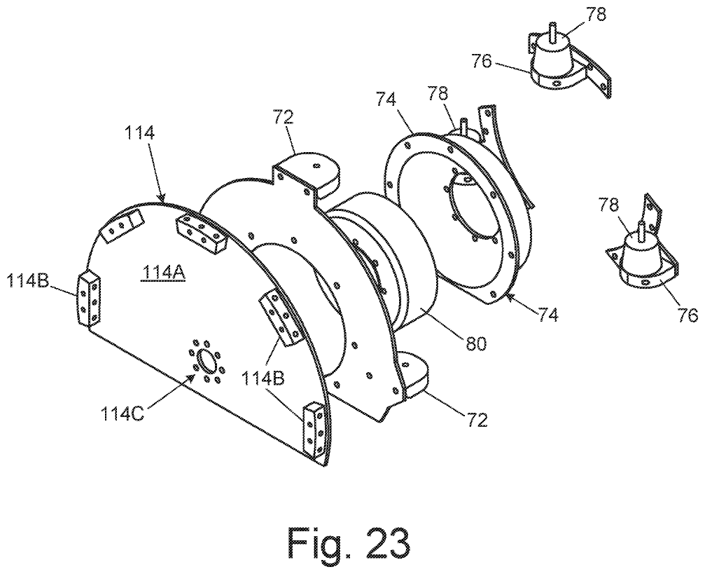

FIGS. 19-23 will be discussed together in conjunction with motor mount assembly 22.

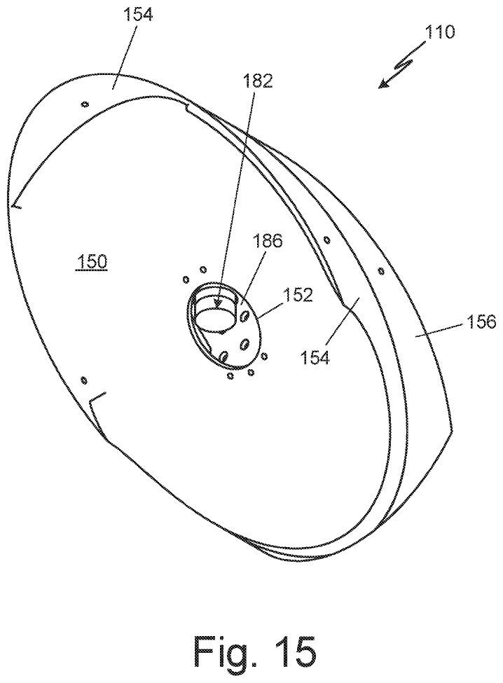

FIGS. 15-23 will be discussed together in conjunction with auto track system 24.

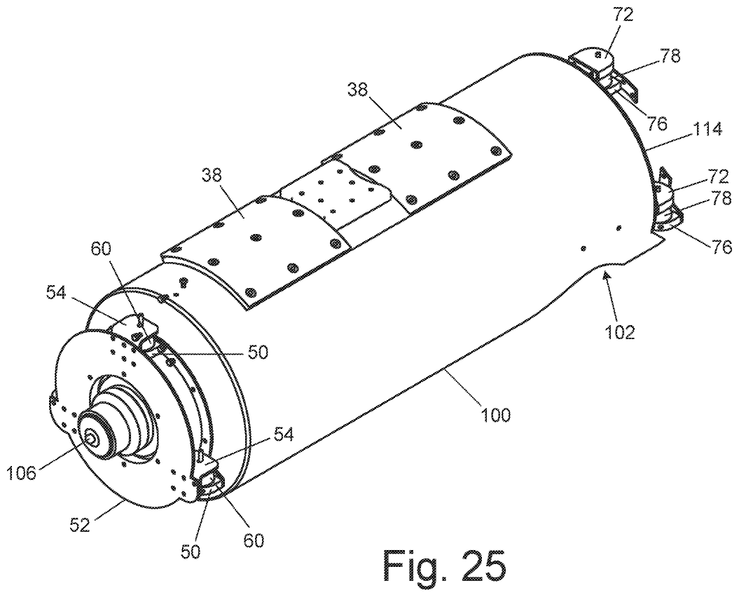

FIGS. 2A, 3A, and 24-25 will be discussed together in conjunction with vibration isolation system 26.

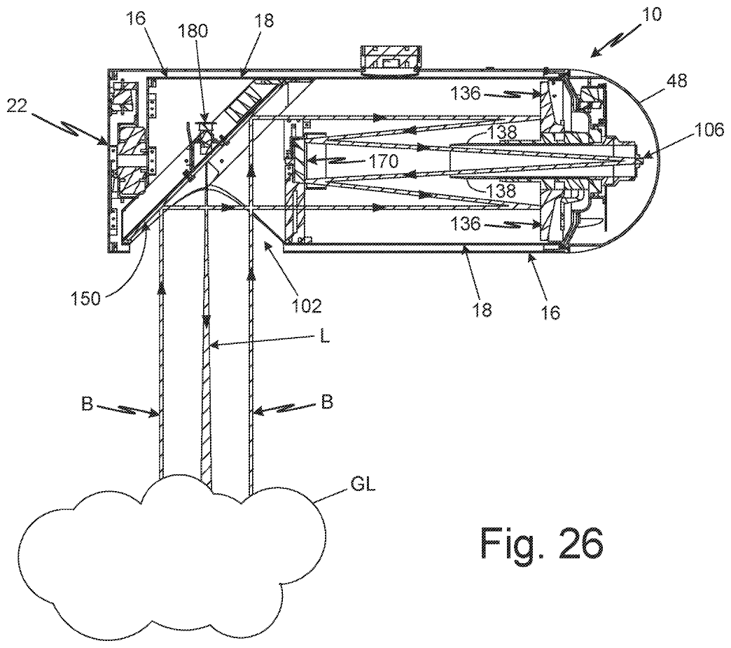

FIG. 26 illustrates gas cloud detection system 28. A laser beam from the scope assembly 18 interacts with a methane gas leak cloud. The interaction includes directing the laser beam toward a potential gas cloud to cause molecules to reflect back toward scope assembly 18, gathering and directing backscattered laser light to scope assembly 18, and sensing the backscattered laser light by scope assembly 18.

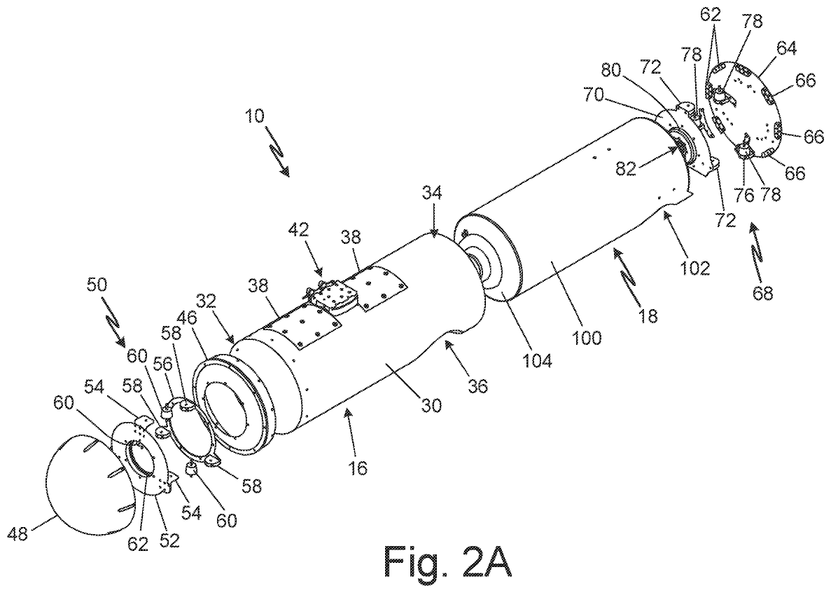

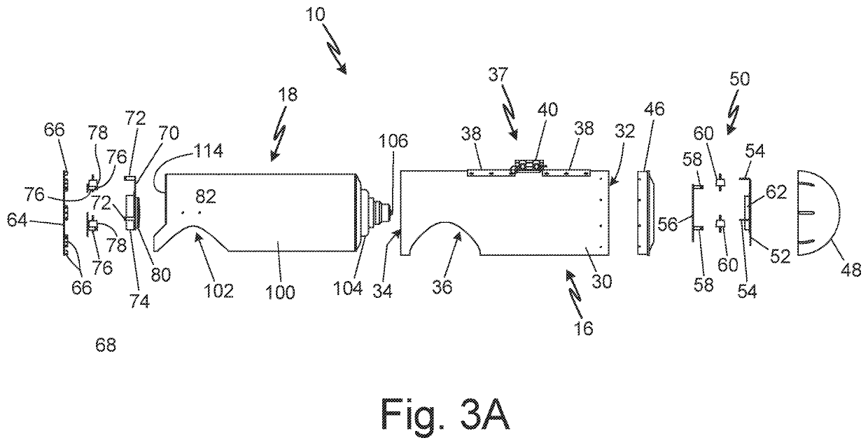

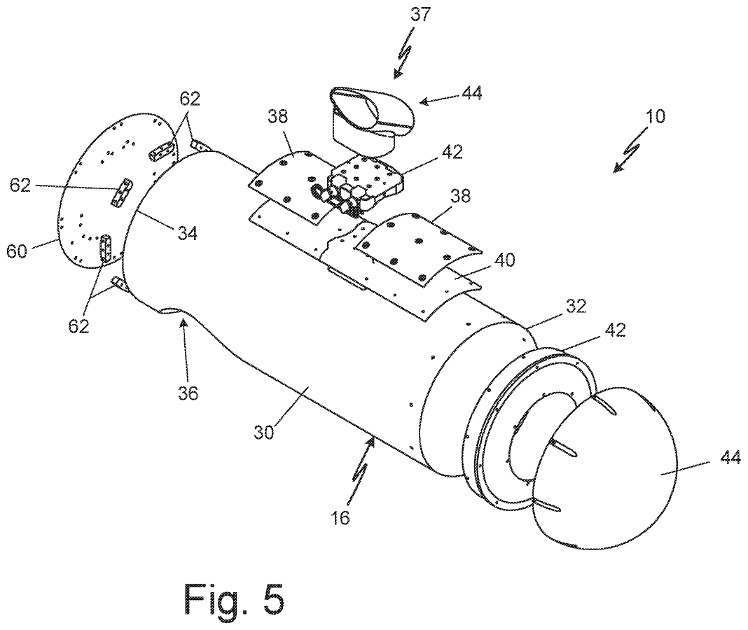

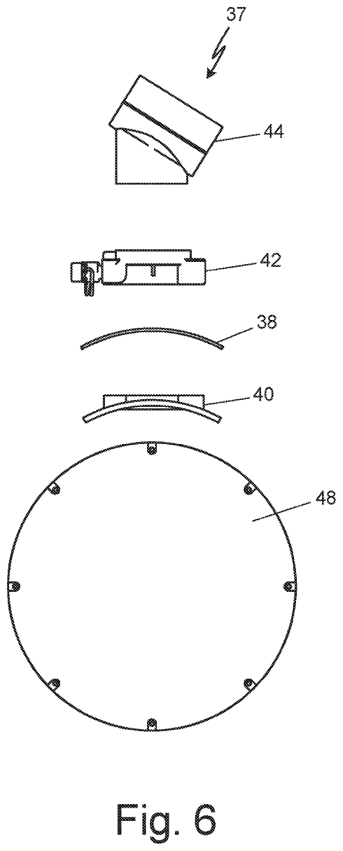

External Shell Assembly 16 FIGS. 2A and 2B are exploded and assembled isometric views the front and left side of pod 10, respectively. FIGS. 3A and 3B are exploded and assembled right side views of pod 10, respectively. FIGS. 4, 5, and 6 are additional exploded views of external shell assembly 16. FIG. 7 is a front view of external shell assembly 16, and FIG. 8 is a vertical sectional view of external shell assembly 16 along section A-A for FIG. 7.

External shell assembly 16 includes main body 30 (with open front end 32, open rear end 34, and external shell window 36), pod mount assembly 37 (including top clamp 38, main frame 40, dovetail clamp 42, and wing strut clamp 44), front cover plate 46, front dome 48, front vibration isolator system 50 (which includes front bracket plate 52, upper tabs 54, rear bracket plate 56, lower tabs 58, and vibration isolators 60), bearing 62, rear plate 64, rear plate mounts 66, rear vibration isolator system 68 (which includes vibration isolator support wall 70 with vibration isolator upper support arms 72, motor mount 74, vibration isolator lower support arms 76, and vibration isolators 78), and electric motor 80 with motor shaft 82.

External shell assembly 16 is the visible part of pod 10 that can be seen from outside without disassembly. External shell assembly 16 is constructed using a combination of materials to provide strength, durability, and light weight.

Main body 30 of external shell assembly 16 is a cylindrical tube with open front end 32, open rear end 34, and external shell window 36. Main body 30 protects the inner workings of pod 10 from wind and precipitation. It also serves as a frame to mount to the internal components housed within external shell assembly 16. In one embodiment, main body 30 is a carbon fiber structure.

Main frame 40 is mounted on an inner wall of main body 30. Main frame 40 serves as an anchor point to secure external shell assembly 16 to dovetail clamp 42. In one embodiment, main frame 40 is made of 6061 aluminum.

Top clamp 38 and dovetail clamp 42 are mounted on the top surface of main body 30 to facilitate connecting of pod 10 to wing strut 12 (shown in FIGS. 1A and 1B). Top clamp 38 secures main body 30, and may be made, for example, of 6061 aluminum. Dovetail clamp 42 serves as an anchor to secure main frame 40 to wing strut clamp 44. Wing strut 12 of aircraft 14 is connected to wing strut clamp 44 to secure pod 10 to wing strut 12.

Front cover plate 46, front dome 48, and front vibration isolator system 50 are mounted to front end 32 of main body 30. Front vibration isolator system 50 (shown in FIGS. 2A and 3A) includes front bracket plate 52 with upper tabs 54, rear bracket plate 56 with lower tabs 58, and vibration isolators 60. Bearing 62 is mounted on bracket plate 52.

Front cover plate 46 is made of metal, such as 6061 aluminum. Front cover plate 46 gives strength and rigidity to external shell assembly 16 and serves as a mounting location for internal scope assembly 18.

Front dome 48 is made of plastic. Its purpose is to protect the inner workings for pod 10 from wind and precipitation. Front cover plate 46, and front dome 48 cover open end 32, so that inner components of external shell assembly 16 and scope assembly 18 are protected.

Rear plate 64 covers open rear end 34 of main body 30. Rear plate mounts 66 attach rear plate 64 in the inner wall of main body 32. Rear vibration isolator system 68 includes vibration isolator support wall 70 with vibration isolator upper support arms 72, motor mount assembly 74, vibration isolator lower support arms 76, and vibration isolators 78. Rear vibration isolator system 68, electric motor 80, and motor shaft 82 are housed in external shell assembly 16 between rear plate 64 and the rear portion of scope assembly 18. Motor shaft 82 is connected to scope assembly 18, so that scope assembly 18 can be rotated by electric motor 80 in a clockwise or counter-clockwise direction with respect to external shell assembly 16. This feature is used in auto track system 24.

Rear plate 64 is made of carbon fiber. This gives strength and rigidity to external shell assembly 16 and serves as a mounting location for vibration isolators 78 and scope assembly 18.

Rear plate mounts 66 are made of 6061 aluminum. Rear plate mounts 66 serve as a bracket structure to secure rear plate 64 to open rear end of main body 30.

External shell window 36 is a cutout in main body 30. External shell window 36 is sized to give a clear view of the pipeline, and is located near the rear end of the main body 30.

In FIGS. 7 and 8, scope assembly 18 (which is normally rotatably mounted within external shell assembly 16) is not shown. In FIG. 7, only top clamp 38, dovetail clamp 42, and front dome 48 can be seen. In FIG. 8, the sectional view shows main body 30, open front end 32, open rear end 34, external shell window 36, top clamp 38, main frame 40, dovetail clamp 42, front cover plate 46, front dome 48, rear plate 64, rear plate mount 66, and main frame 40. The interior of external shell assembly 16 is sized to contain scope assembly 18 and to allow scope assembly 18 to rotate the of about longitudinal axis of main body 30. External shell assembly 16 protects scope assembly 18 from vibration, wind, and precipitation.

### Scope Assembly 18

Scope assembly 18 is coaxially located within external shell assembly 16. Scope assembly 18 includes an optical sensing system that directs a laser beam downward toward the pipeline area being monitored for a gas leak, and that receives and detects backscattered laser light reflected by gas leak methane molecules. The reflected backscattered laser light is collected and directed through a multiple mirror system to a photon detector within scope assembly 18. Scope assembly 18 also includes a downward facing video camera 182 that provides video of the path of the pipeline being inspected. Scope assembly 18 is rotatable within external shell assembly 16 about a longitudinal roll axis that will be parallel to the roll axis of aircraft 14 when pod 10 is mounted to strut 12 of aircraft 14.

Exploded views in FIGS. 2A and 3A show portions of scope assembly 18, including scope tube 100, scope window 102, and primary mirror holder 104. FIG. 3A also shows primary mirror holder 104 and photon detector 106.

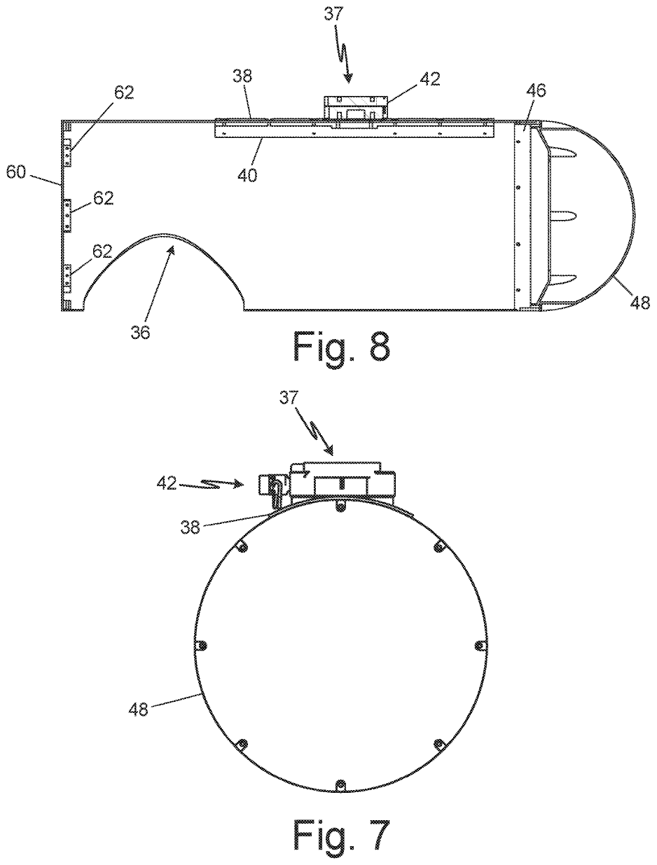

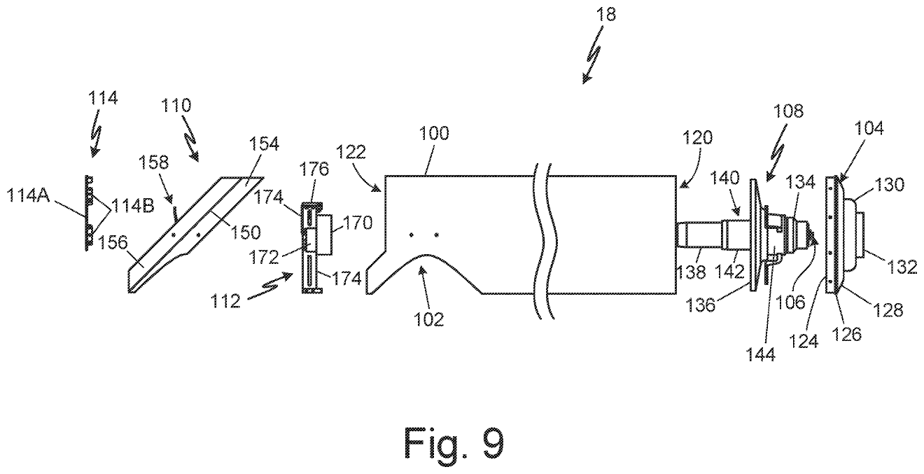

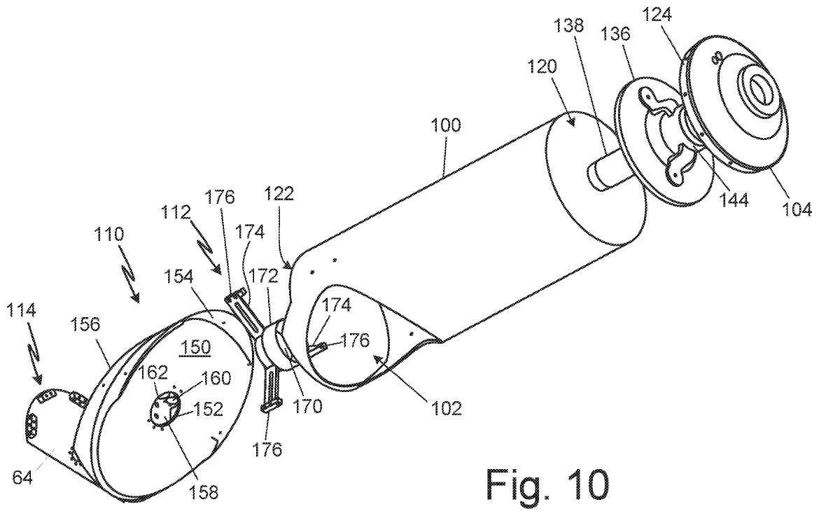

FIG. 9 is an exploded side view of scope assembly 18. FIG. 10 is an exploded isometric view of scope assembly 18. FIG. 11 is a cross-sectional view of assembled scope assembly 18. The main components shown in FIGS. 9, 10, and 11 include scope tube 100, scope window 102, primary mirror holder 104, photon detector 106, primary mirror 108, collection mirror 110, secondary mirror 112, and scope rear wall 114.

Scope tube 100 is a cylindrical tube having an open forward end 120 and an open rearward end 122. Scope tube 100 provides a rigid frame for primary mirror holder 104 for securing primary mirror 108, collection mirror 110, and secondary mirror 112. In one embodiment, scope tube 100 is made of a carbon material.

Scope window 102 is an opening in the bottom of scope tube 100 that is near the rear of scope tube 100. Scope window 102 is generally aligned with external shell window 36 when scope tube 100 is located within external shell assembly 16. This allows the laser beam to be directed downward through scope window 102 and through external shell window 36 toward the pipeline that is being inspected for a gas leak. Scope window 102 also allows scope tube 100 to collect back scattered laser light produced when the laser beam interacts with methane molecules. The back scattered laser light enters scope tube 100 through external shell window 36 and scope window 102, and the backscattered infrared light is directed to photon detector by a series of three mirrors located within scope tube 100. Collection mirror 110 reflects the backscattered laser light to primary mirror 108. Primary mirror 108 reflects the light from primary mirror 108 to secondary mirror 112. Secondary mirror 112 reflects the light into light collection tube 138, which guides the light to photon detector 106.

Primary mirror holder 104 holds primary mirror 108 in place at the forward end of scope tube 100. Primary mirror holder 104 is a hollow one-piece structure that includes mounting ring 124, rib 126, tapered section 128, shoulder 130, and bearing support ring 132. Mounting ring 124 is sized to insert into open end 120 of scope tube 100 and engage the inner surface of scope tube 100. Rib 126 abuts the forward end of scope tube 100 to limit the extent to which mounting ring 124 extends into open end 120. Bearing support ring 132 supports bearing 62 (shown in FIG. 3A)

Photon detector 106 collects and measures photons that have been backscattered from interaction of the laser beam with a methane gas leak. Photon detector 106 is mounted on end cap 134, which is attached to primary mirror 108.

Primary mirror 108 collects light from collection mirror assembly 20 and focuses the light on secondary mirror 112. Primary mirror 108 includes primary reflector 136, light collection tube 138, and sleeve 140 (which has a smaller diameter section 142 and a larger diameter section 144). Primary reflector 136 reflects light received from collection mirror assembly 20 to secondary mirror 112. Light collection tube 138 receives reflected light from secondary mirror 112 and delivers the received light through light collection tube 138 to photon detector 106.

Collection mirror 110 collects the backscattered light received through scope window 102 and focuses the light on primary mirror 136. Collection mirror 110 includes angled mirror 150 with central aperture 152, forward mirror bracket 154, rear mirror bracket 156, and mounting bracket 158 with laser mount hole 160 and video camera mount hole 162. Collection mirror 110 is mounted within scope tube 100 with angled mirror 150 being inclined at 45° to the longitudinal central axis of scope assembly 18.

Secondary mirror 112 is mounted within scope tube 100 between scope window 102 and primary mirror 108. Secondary mirror 112 includes secondary mirror reflector 170, shroud 172, three mounting arms 174, and three mounts 176. Mounting arms 174 are spaced 120 degrees apart, and they are attached to the inner wall of scope tube 100 by mounts 176. Secondary mirror 112 is positioned within scope tube 100 to collect light from primary mirror 136 and to focus the light so that it passes into light collection tube 138 and is received by photon detector 106.

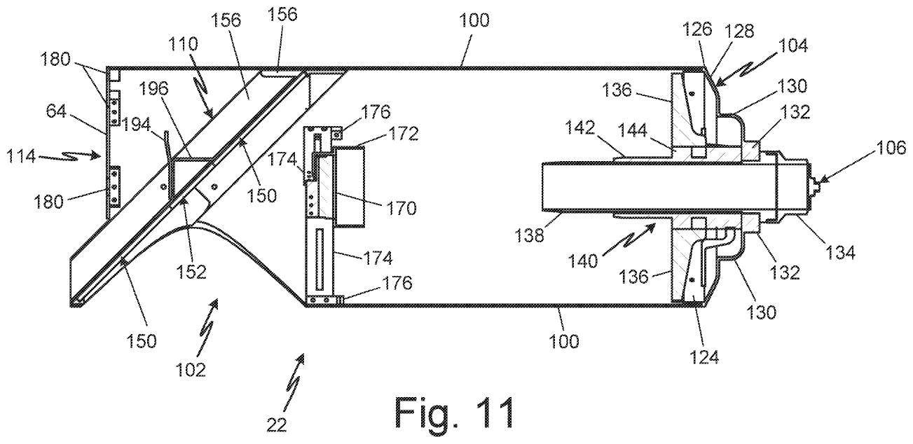

Scope rear wall assembly 114 (which includes rear wall 114A, mounts 114B, and mounting holes 114° C.) provides a closure of open rear end 122 of scope tube 100. It also serves as an attachment point for rotor shaft 82 and scope assembly 18. Therefore, rotation of rotor shaft 82 under control of pipeline auto-track computer 190, provides rotation of scope assembly 18 with respect exterior shell assembly 16. FIG. 12 is a bottom view of pod 10. External shell assembly 18, main body 30, scope window 102, external shell window 36, front dome 48, scope window 102, angled mirror 150, aperture 152, laser 180, and video camera 182. Laser 180 and video camera 182 are downward facing through aperture 152, scope window 102, and external shell window 36. As shown in FIGS. 12 and 15-19, laser 180 and video camera 182 are mounted to 45° collection mirror 110 by mounting bracket 158, which includes mount 184 and bracket 186.

### Collection Mirror Assembly 20

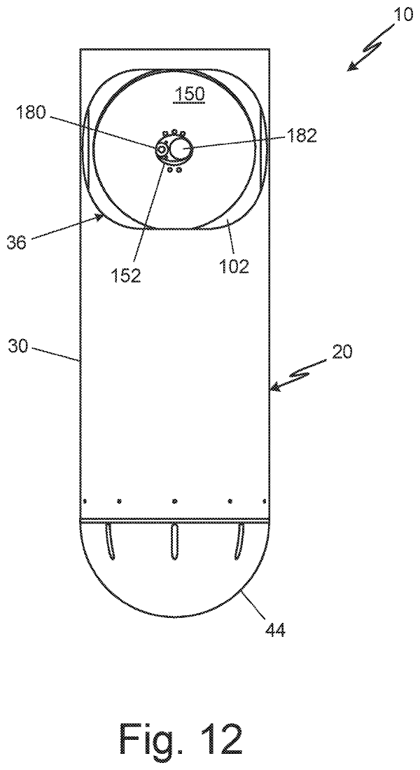

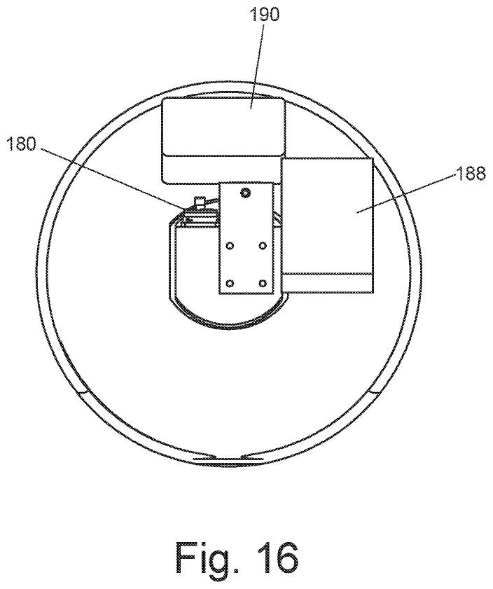

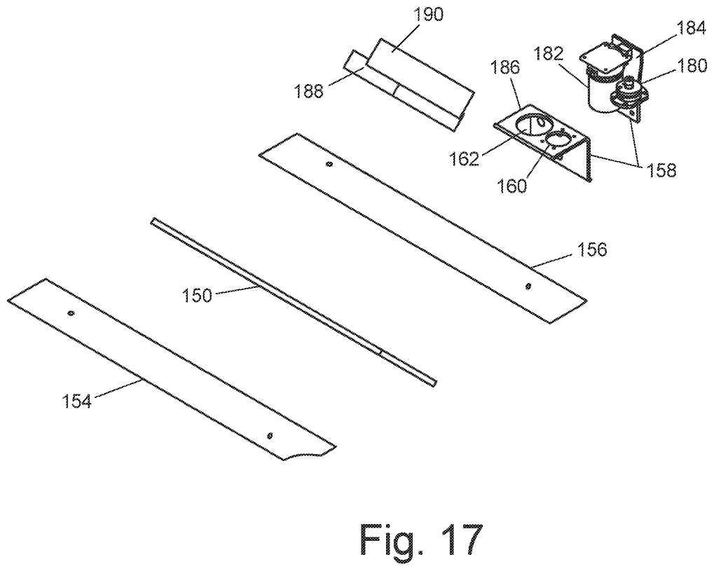

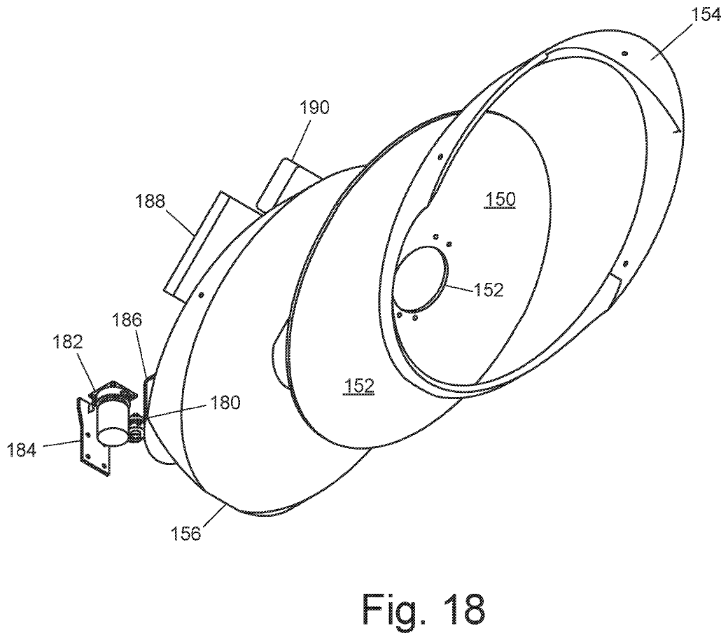

FIGS. 13-18 show collection mirror assembly 20 in greater detail. They will be discussed together. FIG. 13 is a front view of collection mirror assembly 20. FIG. 14 is a cross-section view of collection mirror assembly 20 along section B-B in FIG. 13. FIG. 15 is an isometric view of collection mirror assembly 20. FIG. 16 is a rear view; FIGS. 17 and 18 are exploded views of collection mirror assembly 20.

Collection mirror assembly 20 includes collection mirror 110 (which includes angled mirror 150 with central aperture 152), forward mirror bracket 154, rear mirror bracket 156, and mounting bracket 158 with laser mount hole 160 and video camera mount hole 162, tunable diode laser 180, downward facing video camera 182, mount 184, bracket 186, electronics unit 188, and pipeline auto-track computer 190. Collection mirror assembly 20 serves as the electronics backbone of pod 10. It is the central location to house and protect the electronics components of pod 10.

Angled mirror 150 is a flat, circular mirror 150 that is oriented at 45° to the longitudinal axis of scope assembly 18. Angled mirror 150 reflects backscattered light to primary mirror 108. Angled mirror 150 is made of glass.

Front mirror bracket 154 and rear mirror bracket 156 hold angled mirror 150 in place within scope assembly 18. Mirror brackets 154 and 156 are made of plastic.

Downward facing video camera 182 produces a camera feed that is displayed on a monitor in the cabin of aircraft 14. It gives the operator a view of where laser 180 is pointed to ensure laser 180 is pointed correctly at or near the pipeline. It also can provide video data that can be used by pipeline auto-track computer 190 to control rotation of scope assembly 18.

Pipeline auto-track computer 190 is mounted on the rear side of angled mirror 150. It controls motor 80 to turn scope assembly 18 to keep laser 180 pointed at the downwind side of the pipeline.

Electronics unit 188 controls laser 180. It also interprets data from photon detector 106 to measure the amount of methane that is being detected.

### Motor Mount Assembly 22

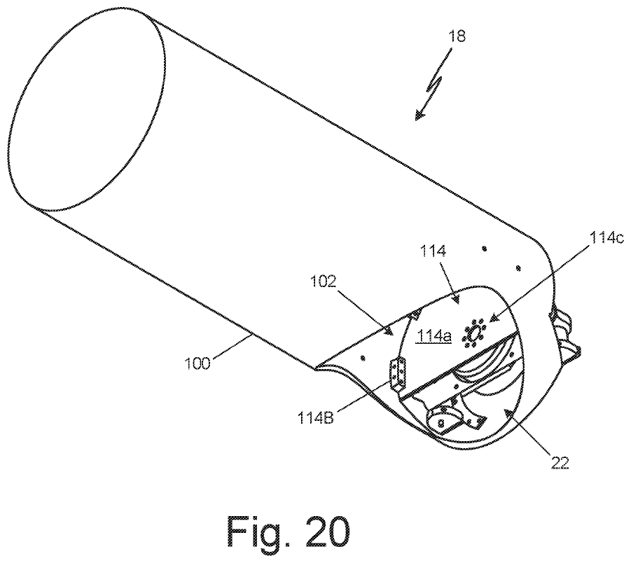

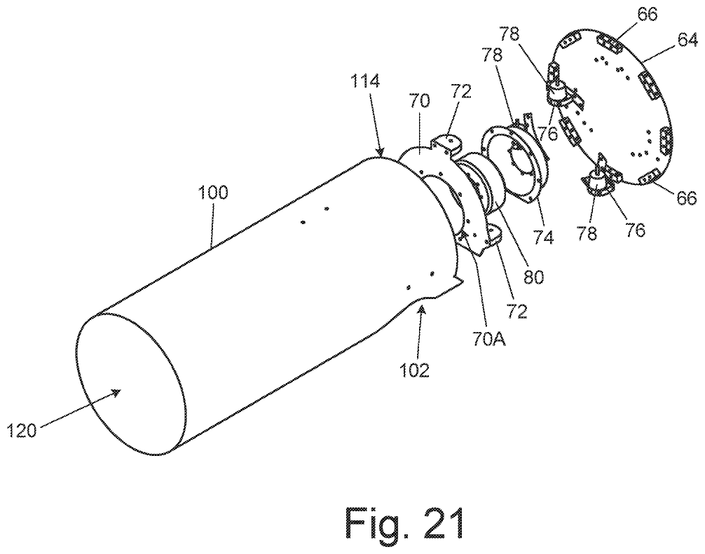

FIGS. 19-23 show motor mount assembly 22. FIGS. 19 and 20 are assembled views showing motor mount assembly 22 connected to the rear end of scope assembly 18. FIGS. 21-23 are exploded views of motor mount assembly 22.

Scope assembly 18 includes scope tube 100, scope window 102, primary mirror holder 104, photon detector 106. Scope rear wall assembly 114 includes rear wall 114A, mounts 114B, and mounting holes 114C. Primary mirror holder 104 is mounted to open forward end 120. Scope rear wall 114A is attached by brackets 114B to scope tube 100 at open rearward end 122. Motor shaft 82 of motor 80 is attached to scope rear wall 114A, so that rotation of motor rotor 82 causes the scope assembly 18 to rotate. Mounting holes 114C align with holes in motor shaft 82 to facilitate connection (e.g. by bolts) of motor shaft 82 to scope rear wall 114A.

Motor mount assembly 22 includes rear plate 64, rear plate mounts 66, rear vibration isolator system 68 (shown in FIGS. 2A and 3A). Rear vibration isolator system 68 includes vibration isolator support wall 70 with vibration isolator upper support arms 72, motor mount 74, vibration isolator lower support arms 76, and vibration isolators 78. Motor mount 74 secures motor 80 to rear plate 64, which is attached to main body 30 of external shell assembly 16. Vibration isolator support wall 70 includes a hole through which the front portion of motor extends, which allows motor shaft 82 to contact and be attached to scope rear wall 114A. Vibration isolator lower support arms 76 support the weight of vibration isolators 78. Vibration isolator upper support arms 72 rest on the upper ends of vibration isolators 78. In this embodiment, three equally spaced vibration isolators 78 are used to isolate scope from vibration and effects of wind.

### Auto-Track System 24

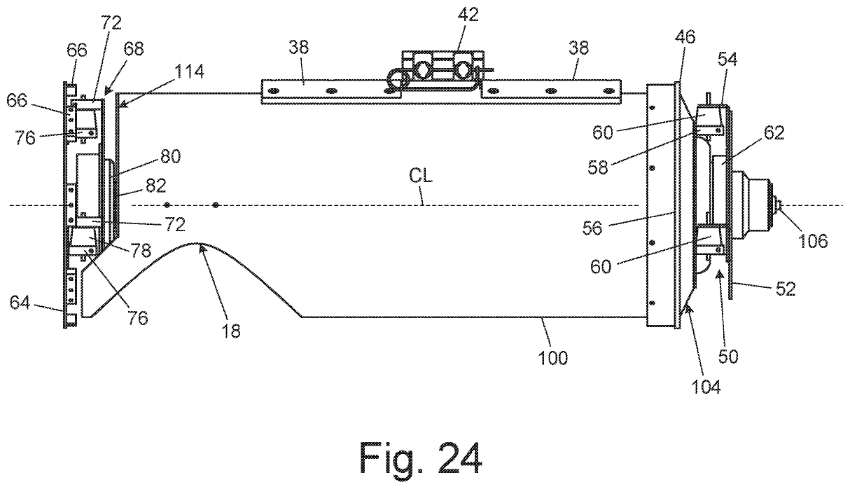

Auto-track system 24 is shown in FIG. 24, with main body 30 and front dome 48 of external shell assembly 16 removed. Components shown in FIG. 24 include top clamp 38, dovetail clamp 42, front cover plate 46, front vibration isolator system 50 (which includes front bracket plate 52, upper tabs 54, rear bracket plate 56, lower tabs 58, and vibration isolators 60), bearing 62, rear plate 64, rear plate mounts 66, rear vibration isolator system 68 (which includes vibration isolator support wall 70 with vibration isolator upper support arms 72, motor mount 74, vibration isolation lower support arms 76, and vibration isolators 78), electric motor 80, motor shaft 82. Also shown are scope tube 100, mirror holder 104, and scope rear wall 114A.

Axial centerline CL shown in FIG. 24 represents the central axis of pod 10, external shell assembly 16 and scope assembly 18. Centerline CL passes through the center of motor shaft 82 at the rear end of pod 10, and through the center of front bearing 62 at the front end of pod 10. External shell assembly 16 is coaxial with scope assembly 18. Scope assembly 18 is stabilized using motor 80 and pipeline auto-track computer 190. Scope assembly 18 pivots or rotates as needed to keep laser 180 and collection mirror 20 pointed in the correct direction over the pipeline.

Vibration Isolation System 26 FIGS. 2A, 3A, and 21-25 depict vibration isolation system 26, which protect laser 180, electronics unit 188, and pipeline auto-track computer 190 from the harmful effects of the aircraft engine vibration is critical for accuracy and reliability of pod 10.

Scope assembly 18 rests on six vibration isolators, although different numbers of vibration isolators can be used. Three spaced vibration isolators 60 are located at the front end of scope assembly 18. Three vibration isolators 78 are at the rear end of scope assembly 18.

### Gas Cloud Detection System 28

Gas cloud detection system 28 shows laser beam L produced by tunable diode laser 180 being directed downward through scope window 102 and external shell window 36 toward gas leak cloud GL. As laser beam L intersects with gas leak cloud GL, some of the laser beam light reflects off the methane gas molecules and reflects back toward pod 10. The backscattered infrared light that follows a path upward toward pod 10 will be collected. Backscattered light B that enters pod 10 through scope window 102 will be reflected by angled mirror 150, which is angled 45°, to primary mirror 136. Backscattered light B is reflected by primary mirror 136 to secondary mirror 170. In turn, secondary mirror 170 reflects backscattered light B into light collection tube 138 and to photon detector 106.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention will not be limited to the particular embodiment(s) disclosed, but that the invention will include all embodiments falling within the scope of the appended claims.

1. An aerial methane gas leak detection pod comprising:
an external shell assembly including a main body having a front end, a rear end, and an external shell window in a wall of the main body;
a scope assembly coaxially about a longitudinal axis within the external shell assembly, the scope assembly including a scope tube, a rear end, a front end, and a scope window in a wall of the scope tube;
an infrared laser mounted within the scope assembly and positioned to direct an infrared laser beam out through the scope window and the external shell window;
a photon detector mounted on the scope assembly for receiving backscattered infrared light produced by the interaction of the infrared laser beam with a methane gas leak; and
a mirror system mounted within the scope assembly to collect the backscattered infrared light received through the scope window and to direct the backscattered infrared light to the photon detector.

2. The aerial methane gas leak detection pod of claim 1, and further comprising:
a front vibration isolator system connected between the external shell assembly and the scope assembly; and
a rear vibration isolator system connected between the external shell assembly and the scope assembly.

3. The aerial methane gas leak detection pod of claim 2 wherein the front vibration isolator system includes a plurality of spaced vibration isolators, and the rear vibration isolator system includes a plurality of rear vibration isolators.

4. The aerial methane gas leak detection pod of claim 3 and further comprising:
an electric motor having a motor shaft;
a motor mount that connects the electric motor to the rear end of the main body; and
a scope rear wall attached to the motor shaft so that rotation of the electric motor shaft causes the scope assembly to rotate relative to the external shell assembly.

5. The aerial methane gas leak detection pod of claim 4 and further comprising:
a bearing mounted at the front vibration isolator system.

6. The aerial methane gas leak detection pod of claim 1, wherein the mirror system includes a collection mirror adjacent the scope window.

7. The aerial methane gas leak detection pod of claim 6, wherein the collection mirror comprises a flat angled mirror with a central aperture, and wherein the angled mirror is positioned at 45° to a longitudinal axis.

8. The aerial methane gas leak detection pod of claim 7 and further comprising a primary mirror positioned to receive the backscattered infrared light from the collection mirror and reflect the backscattered infrared light to a secondary mirror.

9. The aerial methane gas leak detection pod of claim 8 wherein the secondary mirror is positioned to receive the backscattered infrared light from the primary mirror and reflect the backscattered infrared light toward the photon detector.

10. The aerial methane gas leak detection pod of claim 9, and further including a light collection tube that extends through the primary mirror for directing the backscattered infrared light from the secondary mirror through the light collection tube to the photon detector.

11. The aerial methane gas leak detection pod of claim 7, wherein the infrared laser is mounted to direct the infrared laser beam through the central aperture of the flat angled mirror.

12. The aerial methane gas leak detection pod of claim 7, and further including a video camera mounted to view downward through the central aperture of the angled mirror, through the scope window, and through the external shell window.

13. An aerial methane gas leak detection pod comprising:
a scope assembly including:
a scope tube;
a scope window in the scope tube;
an infrared laser mounted in the scope tube to direct an infrared laser beam through the scope window;
a video camera mounted in the scope tube;
a photon detector; and
a mirror system mounted within the scope tube to collect backscattered infrared light received through the scope window and to direct the backscattered infrared light to the photon detector;
an external shell assembly that surrounds and is coaxial with the scope assembly, the external shell assembly including:
a main body having a front end, a rear end, and an external shell window in a wall of the main body;
a motor mount that is connected to the external shell assembly; and
a motor shaft connected to the scope assembly to rotate the scope assembly within the external shell assembly.

14. The aerial methane gas leak detection pod of claim 13, and further comprising:
a front vibration isolator system connected between the external shell assembly and the scope assembly; and
a rear vibration isolator system connected between the external shell assembly and the scope assembly.

15. The aerial methane gas leak detection pod of claim 14 wherein the front vibration isolator system includes a plurality of spaced vibration isolators, and the rear vibration isolator system includes a plurality of rear vibration suppressors.

16. The aerial methane gas leak detection pod of claim 13, wherein the mirror system includes a collection mirror adjacent the scope window.

17. The aerial methane gas leak detection pod of claim 9, wherein the collection mirror comprises a flat angled mirror with a central aperture, and wherein the angled mirror is positioned at 45° to a longitudinal axis.

18. The aerial methane gas leak detection pod of claim 16 and further comprising:
a primary mirror positioned to receive the backscattered infrared light from the collection mirror and reflect the backscattered infrared light to a secondary mirror;
the secondary mirror is positioned to receive the backscattered infrared light from the primary mirror and reflect the backscattered infrared light toward the photon detector; and
a light collection tube that extends through the primary mirror for directing the backscattered infrared light from the secondary mirror through the light collection tube to the photon detector.

19. The aerial methane gas leak detection pod of claim 7, wherein the infrared laser is mounted to direct the infrared laser beam through the central aperture of the angled mirror.

20. The aerial methane gas leak detection pod of claim 7, wherein the video camera is mounted to view downward through the central aperture of the angled mirror, through the scope window, and through the external shell window.
